(19) United States
(12) Patent Application Publication
(10) Pub. No.: US 2006/0109258 A1
(43) Pub. Date: May 25, 2006

(54) Operation input device and electronic device

(76) Inventor: Hiroshi Takisawa, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/258,568

(22) Filed: Oct. 25, 2005

(30) Foreign Application Priority Data
Nov. 22, 2004 (JP) 2004-337756

(51) Int. Cl. G09G 5/00

(52) U.S. Cl. 345/173

(57) ABSTRACT

An operation input device or an electronic device equipped with the operation input device comprises an operation panel which includes a half mirror-deposited film being formed in one surface, and a plurality of touch input sensors of an electrostatic capacity detecting type arranged to face the surface in which the half mirror-deposited film is formed. The operation input device further comprises a light emitting display section which includes light emitting display elements to emit and display a light in positions of the plurality of arranged touch input sensors, and a light emitting display control section which permits light emission only from the light emitting display element corresponding to an operable touch input sensor among the plurality of touch input sensors. As a result, inoperable sections on the operation panel are made difficult to be seen from an operator.

### CROSS-REFERENCE TO RELATED APPLICATION

This application is based upon and claims the benefit of priority from prior Japanese Patent Application No. 2004-337756, filed on Nov. 22, 2004, the entire contents of which are incorporated herein by reference.

### BACKGROUND OF THE INVENTION

1. Field of the Invention

The present invention relates to an electronic device such as a portable type music player and a touch type operation input device disposed in the same.

2. Description of the Related Art

As an operation input section of an electronic device, a touch panel operation section utilizing a display member such as a liquid crystal display panel has recently been put to practical use. In the electronic device that comprises the touch panel operation section, a button input operation is performed by pressing an operation button displayed on a screen of a touch panel.

In such electronic devices equipped with the touch panel operation sections, there is a device which displays a necessary (currently operable) operation button on a screen each time, and displays the pressed operation button in a flashing manner only for a certain period after a finger moves apart therefrom (e.g., Japanese Patent No. 3219761). As a result, an identification of a button currently pressed by a user becomes possible.

However, the touch panel operation section that utilizes the display means such as a liquid crystal panel is relatively expensive, therefore it is difficult to reduce the manufacturing costs. Additionally, for example, in the case of the portable type music player, which is one type of an electronic device, complex operations are often required because of improvements in performance.

Under these circumstances, as a means for solving the problem of complex operations while reducing costs, it is known that improvements of the operation has been tried by lighting an operable operation button itself among a plurality of operation buttons disposed in an operation section or lighting the surroundings of the operable operation button (e.g., Japanese Patent Application Laid-Open Nos. 8-138278 and 2003-125464).

### BRIEF SUMMARY OF THE INVENTION

An operation input device of the present invention comprises an operation panel including a half mirror-deposited film formed on one surface, a plurality of touch input sensors of an electrostatic capacity detecting type arranged to face the surface on which the half mirror-deposited film is formed, a light emitting display section including a light emitting display element for performing light emitting display at a position where each of the plurality of touch input sensors is arranged, and a light emitting display control section for making only the light emitting display element corresponding to an operable touch input sensor among the plurality of touch input sensors to emit light.

Since only a position (or positions) corresponding to the operable touch input sensor is lit, the operation input device has a good operability.

As described below, various features can be added to the operation input device for improving beauty and/or identification performance of the operable touch input sensor, or for other advantages.

The surface opposing to the surface on which the half mirror-deposited film is formed, or at least operation area of the opposing surface, can be made as a smooth monolithic plane.

The surface of the operation panel on which the half mirror-deposited film is formed can be covered with a non-translucent layer except sections corresponding to the positions of the plurality of arranged touch input sensors. In this case, the sections corresponding to the positions of the arranged touch sensors become translucent sections as they are not covered with the non-translucent layer.

The light emitting display elements can illuminate the operation panel through the translucent sections. In this case, the light emitting display elements can be individually arranged with respect to the positions of the translucent sections in the side adjacent to the surface of the operation panel on which the half mirror-deposited film is formed. Additionally, a light-guide section can be included to guide light emitted from the light emitting display elements to the translucent sections, or a light diffusion treatment can be applied to the translucent sections.

The color of the non-translucent layer can be a dark color such that the transparent sections become obscure when being looked from the side opposite to the half mirror deposited surface of the operation panel, or a metal color such as silver, or gold. For example, the dark color is a deep color that can be selected from black, deep blue, deep green, deep brown, deep purple, and deep gray.

For example, brightness of color of the non-translucent layer can be 30% or less, the operation panel can be a transparent plate, or the deposited film can be nonconductive. Moreover, LED elements can be employed for the light emission elements.

Furthermore, the present invention can be directed to an electronic device equipped with the aforementioned operation input device. The electronic device can comprise an operation control section which controls the operation of the electronic device based on inputs from the touch input sensors. The electronic device may further comprise a designation section which designates an operable touch input sensor among the plurality of the touch input sensors based on the operation currently under control of the operation control section, and a light emitting display control section for making the light emitting display section corresponding to the touch input sensor designated by the designation section to emit light.

The operation panel may be formed integrally with a cover that covers an information display section such as a LCD display for displaying the operation state information of the electronic device.

The surface of the operation panel on which the half mirror-deposited film is formed can be covered with a non-translucent layer except for first translucence sections corresponding to positions of the plurality of arranged touch input sensors and a second translucent section corresponding to the information display section. Moreover, the second translucent section can be higher in transparency than the first translucent sections.

This electric device can have a function such that all of the light emitting display elements emit lights for a certain time when a stopped state is changed to a normal operation state, whereby the positions of the touch sensors can be indicated to the operator.

According to the present invention, deposition is not limited to the vacuum-deposition, but includes the sputtering, the ion plating, and similar methods. The half mirror-deposited film includes half mirror layer made by the deposition.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 a perspective view showing an appearance of a player main body 1 in a portable type music player according to an embodiment of the present invention;

FIG. 2 is a perspective view showing a state in which an operation panel 2 is removed from the player main body 1 shown in FIG. 1;

FIG. 3 is a perspective view showing a state in which a backside case 3 is further removed from the state of FIG. 2;

FIG. 4 is a perspective view showing the state of FIG. 3 from the backside;

FIG. 5 is a perspective view showing a state in which a middle frame 4 and a touch pad 5 are removed from the state of FIG. 3;

FIG. 6A is a front plan view of the touch pad 5;

FIG. 6B is a back plan view of the touch pad 5;

FIG. 7A is a back plan view of the operation panel 2;

FIG. 7B is a sectional view cut along the line indicated by arrows;

FIG. 8 is a block diagram showing a main configuration of the portable type music player according to the embodiment;

FIG. 9 is a plan view showing a state of the operation panel at the time of starting the portable type music player;

FIG. 10 is a plan view showing a state of the operation panel after a passage of certain time from the state of FIG. 9;

FIG. 11 is a plan view showing a state of the operation panel at the time of starting music playing from the state of FIG. 10;

FIG. 12 is a plan view showing a state of the operation panel at the time of switching to a submenu screen from the state of FIG. 10; and

FIG. 13 is a plan view showing a state of the operation panel at the time of switching a layer to a lowermost submenu screen.

### DETAILED DESCRIPTION OF THE PREFERRED EMBODIMENT

Preferred embodiment of the invention is described below with reference to the accompanying drawings.

This embodiment of the invention is directed to a portable type music player that is categorized as an electronic device.

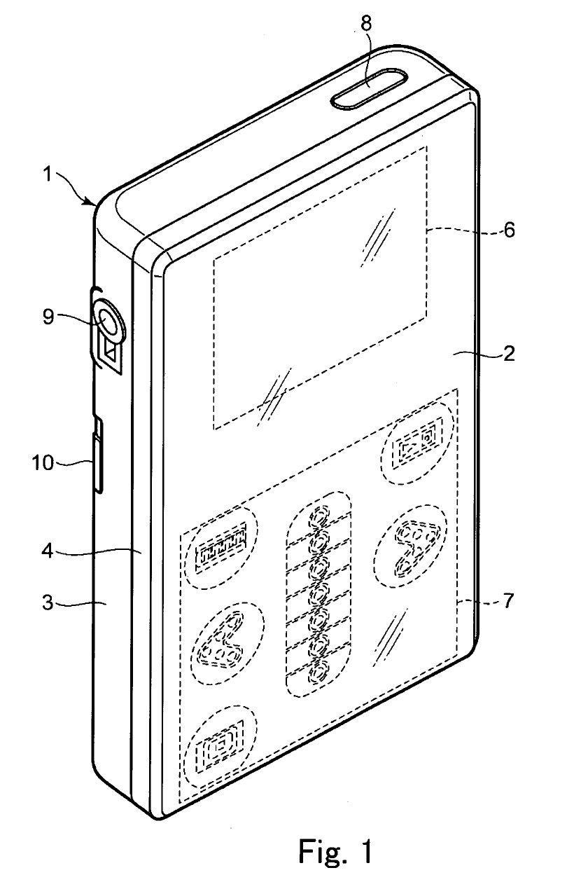

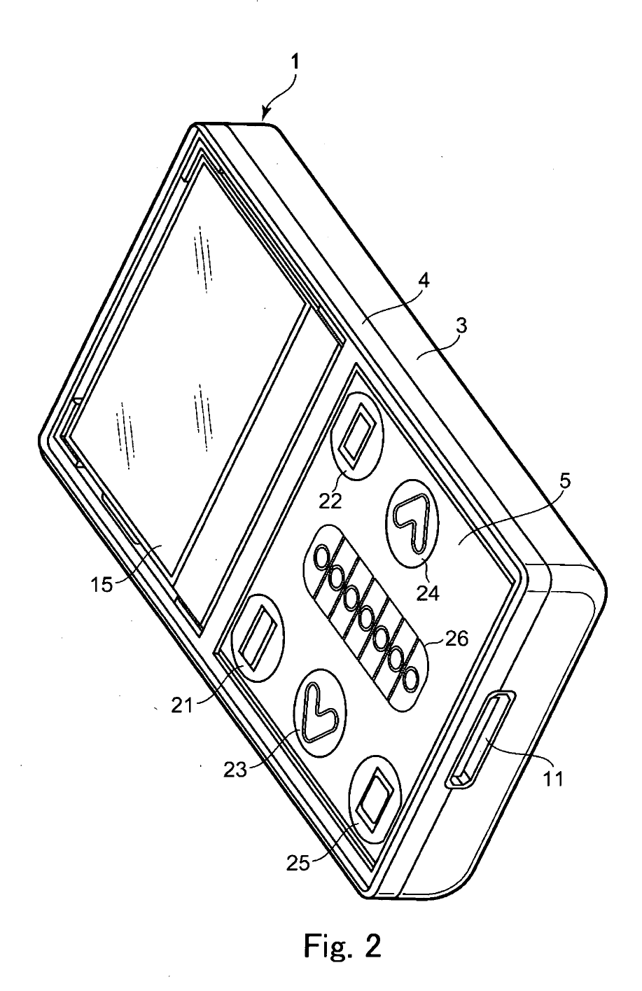

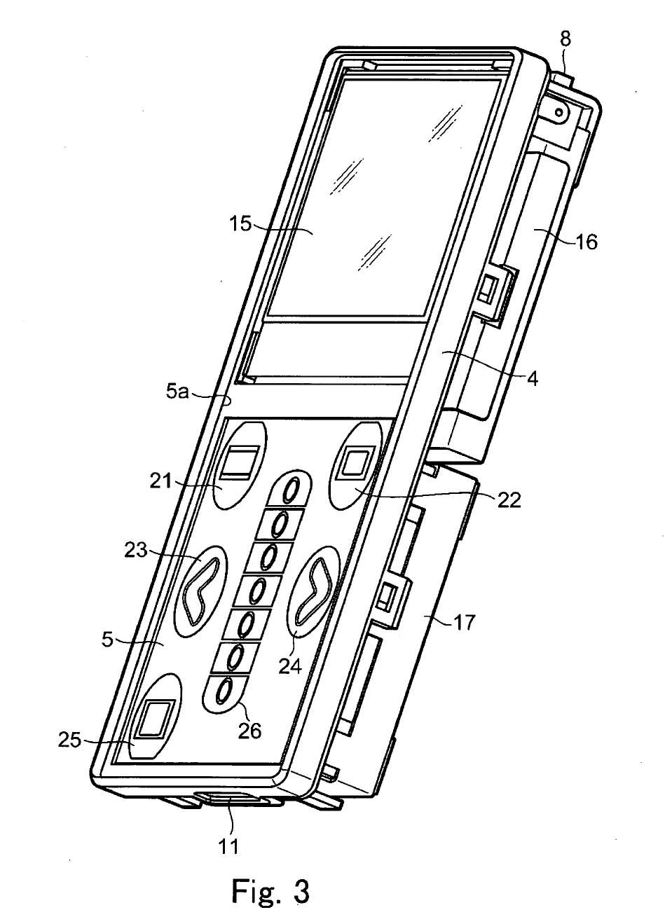

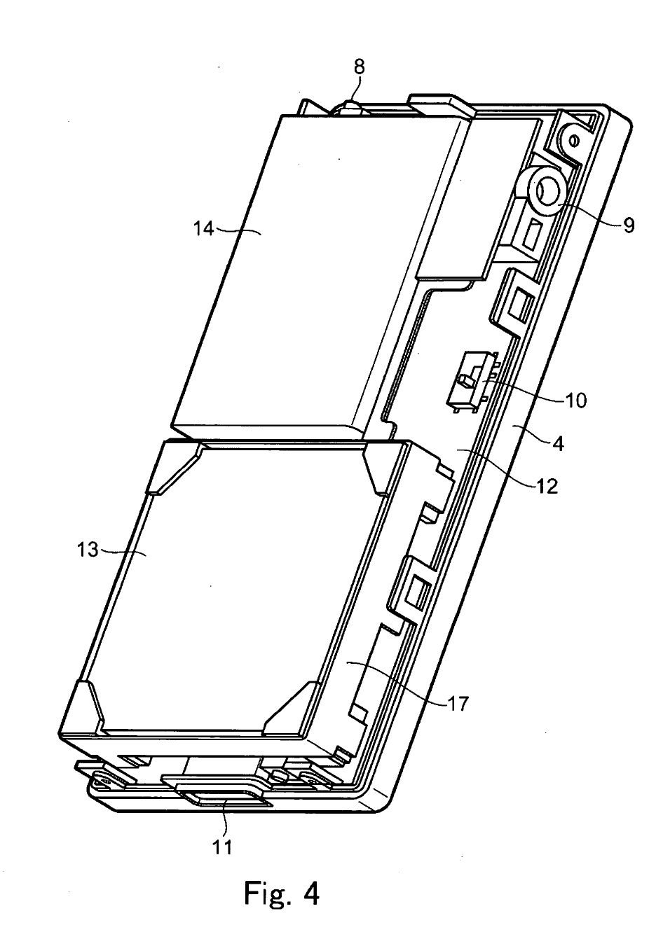

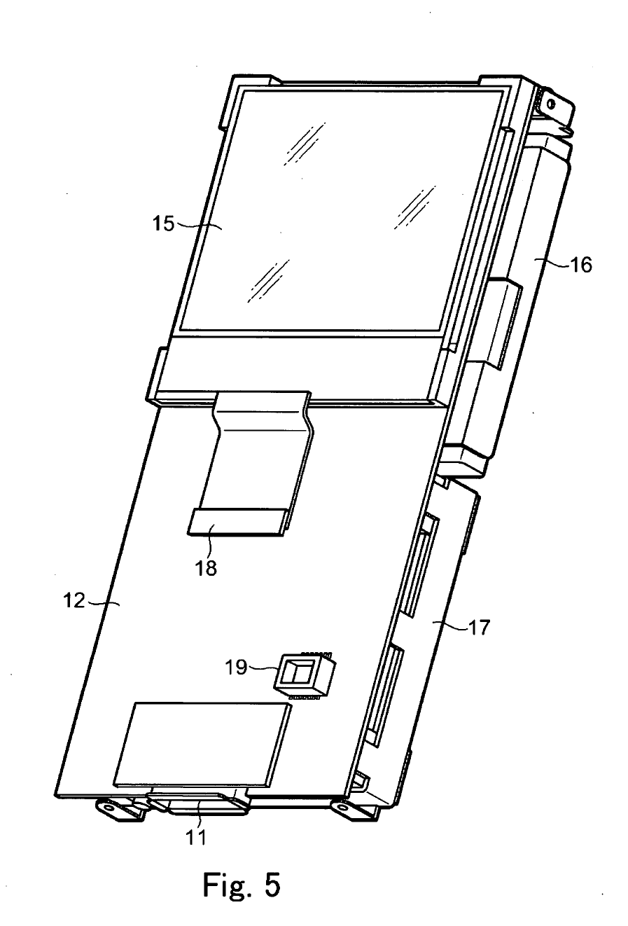

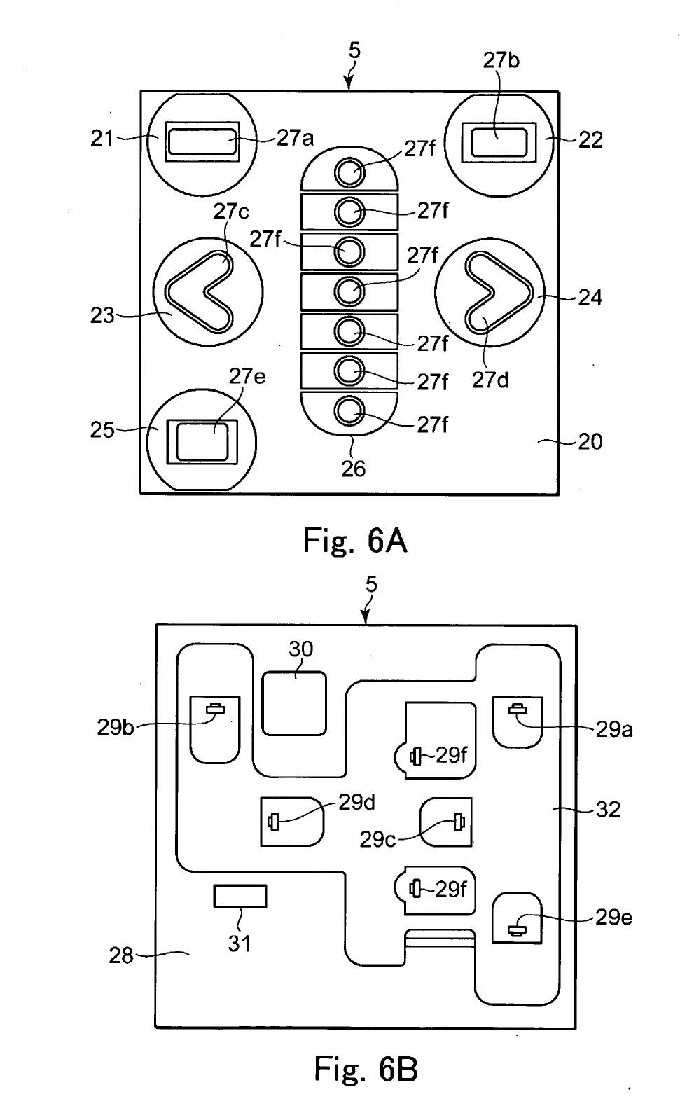

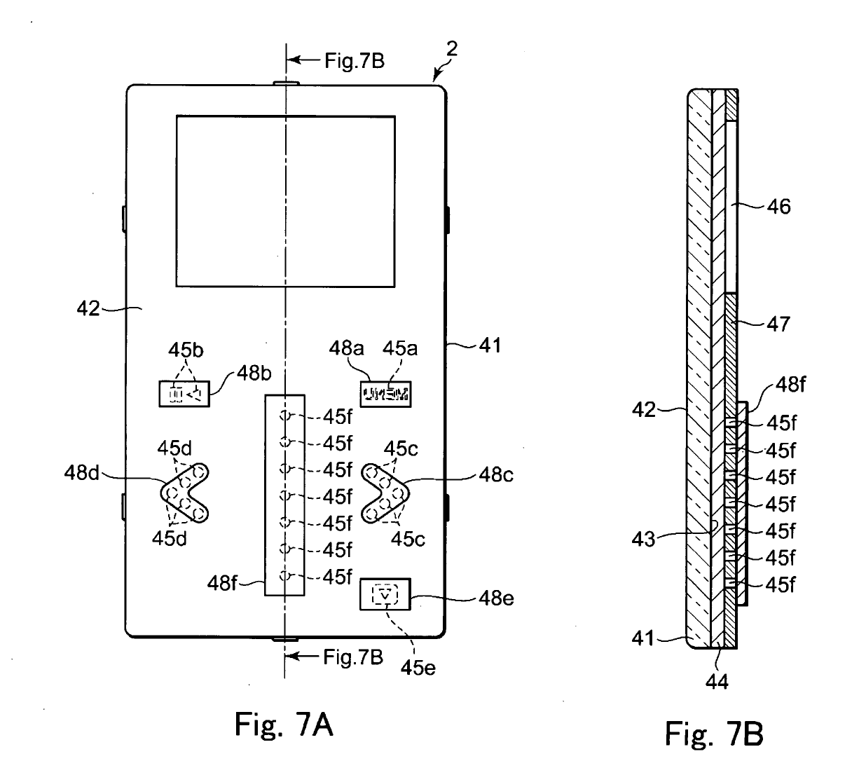

FIGS. 1 to 7B show a structure of the portable type music player of this embodiment. FIG. 1 is an appearance perspective view of a player main body 1, FIG. 2 is a perspective view showing a state in which an operation panel 2 is removed from the player main body 1, FIG. 3 is a perspective view showing a state in which a backside case 3 is removed from the state of FIG. 2, and FIG. 4 is a perspective view showing the state of FIG. 3 from the backside. FIG. 5 is a perspective view showing a state in which a middle frame 4 and a touch pad 5 are moved from the state of FIG. 3, FIGS. 6A and 6B are front and back plan views of the touch pad 5, and FIGS. 7A and 7B are a back plan view of the operation panel 2, and a sectional view thereof cut along the line indicated by arrows.

As shown in FIGS. 1 and 2, the portable type music player of this embodiment comprises the flat rectangular parallelepiped player main body 1. An area as a display section 6 and an area as an operation input section 7 are secured on the front face of the player main body 1. A power switch 8 is disposed in an upper surface of the player main body 1, a headphone connection terminal 9 and a hold switch 10 are disposed in one side face, and a cradle connection terminal 11 is disposed in a bottom surface.

The player main body 1 comprises a concave backside case 3 in which a rectangular opening is formed and a surface facing the opening is set as a backside of the player main body 1, a square-shaped middle frame 4 joined to and mounted on an opening edge of the backside case 3, and the operation panel 2 fitted to and mounted on an inner edge 5a the middle frame 4 (see FIG. 3) that is opposite to the side joined to the backside case 3.

As shown in FIGS. 3 and 4, the player main body 1 incorporates a control substrate 12, a hard disk dive (HDD) 13, a charge battery 14, a liquid crystal display 15, a touch pad 5, and the like. The control substrate 12 is inserted between the front and the back of the player main body 1 almost in parallel therewith to be locked in an inner surface of the middle frame 4.

First and second frames 16 and 17 are formed in the backside of the control substrate 12. The charge battery 14 is mounted on the first frame, and the HDD 13 is mounted on the second frame.

As shown in FIG. 5, first and second connectors 18 and 19 are mounted on the front side of the control substrate 12. The liquid crystal display 15 is connected to the first connector 18, and the touch pad 5 is to be connected to the second connector 19. The liquid crystal display 15 is a thin platelike flat display, and its screen is locked in the middle frame 4 to come into contact with a backside of the display section 6 secured in the front of the player main body 1. The liquid crystal display 15 functions as an information display section to display information regarding to an operation state of the music player, or the like.

As shown in FIG. 6A, the touch pad 5 has a planar operation surface 20. This operation surface 20 is locked in the middle frame 4 to come into contact with a backside of the operation input section 7 secured in the front of the player main body 1. In the operation surface 20 of the touch pad 5, a plurality of operation buttons 21 to 26 necessary for the music player are arranged: 21 is a menu button 21, 22 is a play/stop button, 23 is a backward button, 24 is a forward button, 25 is a display button, and 26 is a scroll button. The operation buttons 21 to 26 are touch input sensors of an electrostatic capacity detecting type for stacking electrode surfaces of left-right and up-down directions and detecting touch operations based on a change in charge capacity. Holes 27a to 27f of predetermined shapes are bored in frames of the operation buttons 21 to 26.

On the other hand, as shown in FIG. 6B, LED elements 29a to 29f which are light emitting display elements corresponding to the holes 27a to 27f, a LED controller 30 for controlling light emission operations of the LED elements 29a to 29f, and a connector 31 connected to the second connector 19 are mounted to a surface 28 opposed to the operation surface 20 of the touch pad 5. A light-guide 32 is fixed to the surface 28 to cover all the holes 27a to 27f. The light-guide 32 functions as a light-guide section to guide lights emitted from the LED elements 29a to 29f under control of the LED controller 30 to the holes 27a to 27f corresponding thereto. In this case, the LED elements 29a to 29f and the light-guide 32 constitute a light emitting display section. The LED controller 30 constitutes a light emitting display control section.

As shown in FIG. 7B, for example, the operation panel 2 uses a thin transparent plate 41 made of an acrylic resin to constitute a main part. The operation panel 2 is fitted to the middle frame 4 accommodating the liquid crystal display 15 and the touch pad 5 in such a manner that a first surface 42 of the transparent plate 41 is directed outside as a front part of the player main body 1. In this case, a predetermined part of the first surface 42 including at least the operation input section 7 of the player main body 1, is a single smooth plane. In other words, it is a plane in which no concave or convex sections are formed in the operation input section 7 to indicate positions of the operation buttons 21 to 26 of the corresponding touch pad 5. The operation panel 2 functions as a cover for the liquid crystal display 15. In other words, the operation panel 2 is formed integrally with a cover to cover the liquid crystal display 15.

In a second surface 43 opposed to the first surface 42 of the transparent plate 41, a deposited film 44 is formed in its entire area. This deposited film 44 causes the transparent plate 41 to act as a half mirror. As the operation buttons 21 to 26 are the touch input sensors of the electrostatic capacity detecting type, a nonconductive deposited film is used for the deposited film 44. A surface of the deposited film 44 is covered with a non-translucent layer 47 except a plurality of first translucent sections 45a to 45f corresponding to positions of the plurality of holes 27a to 27f formed in the opposing operation buttons 21 to 26 and a second translucent section 46 corresponding to a screen position of the liquid crystal display 15. The deposited film 44 is formed between the transparent plate 41 and the non-translucent layer 47. The second translucent section 46 is higher in transparency than the first translucent sections 45a to 45f. A plurality of light diffusion layer portions 48a to 48f are deposited on a surface of the non-translucent layer 47 by print painting to cover the first translucent sections 45. As a result, a light diffusion processing is applied at each of the first translucent sections 45a to 45f.

For example, the non-translucent layer 47 is a black layer formed by black mono-color painting, which is dark enough to make the first translucent sections 45a to 45f obscure when observed from side of the first surface 42 of the transparent plate 41, i.e., from the front side of the operation panel 2. More specifically, for example, brightness of color of the non-translucent layer 47 is 30% or less. The dark color is not limited to black, but it may be one selected from deep colors such as deep blue, deep green, deep brown, deep purple, and deep gray. It may also be a metal color such as silver or gold.

Because of the light diffusion processing, the first translucent sections 45a to 45f are more difficult to be noticed than the second translucent section 46 of no light diffusion processing. However, similar effects can be obtained by different methods, e.g., by reducing transmittance of the first translucent sections 45a to 45f by applying color without using a light diffusion processing. According to the embodiment, the light diffusion processing is not applied to the second translucent section 46 because it is not necessary to make it hard to be seen. However, the above or similar processing can be applied when the obscurity is desirable.

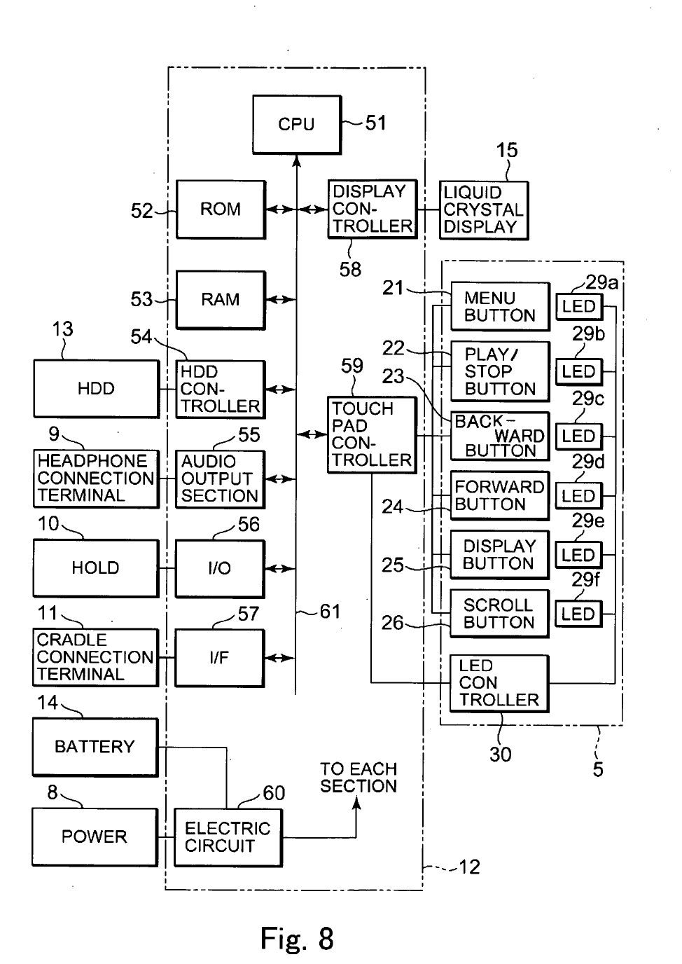

FIG. 8 is a block diagram showing a main configuration of the portable type music player according to the embodiment. This portable type music player comprises a CPU 51 constituting a main control section, a ROM 52 for prestoring predetermined data such as a program or the like, a RAM 53 for storing various data in a rewritable manner, an HDD controller 54 for controlling writing/reading of data with the HDD 13, and an audio output section 55 for converting digital music data stored in the HDD 13 into analog data to output it to a headphone connected to the headphone connection terminal 9. These parts are mounted on the control substrate 12. Further, the control substrate 12 are mounted with an I/O port 56 for inputting a signal of the hold switch 10, an interface 57 for communicating data with a personal computer or the like via a cradle (not shown) connected to the cradle connection terminal 11, a display controller 58 for controlling screen displaying of the liquid crystal display 15, a touch pad controller 59 for controlling the touch pad 5, and a power supply circuit 60 for generating driving power of a predetermined voltage from a power of the charge battery 14 to supply it to each section. The CPU 51, the ROM 52, the RAM 53, the HDD controller 54, the D/A converter 55, the I/O-port 56, the interface 57, the display controller 58, and the touch pad controller 59 are interconnected through a system bus 61.

The portable type music player thus configured can charge the battery 14 by connecting the cradle to the cradle connection terminal 11. It can load music data from the personal computer connected via the cradle to save them in the HDD 13.

The portable type music player can reproduce music data saved in the HDD 13, or perform other functions, with the battery 14 as a power source when it is removed from the cradle. Specifically, first, the power switch 8 is operated to supply power. Then, driving power is supplied from the power supply circuit 60 to the sections including the CPU 51, and the sate of the portable type music player is changed from a stopped state to a normal operation state (a starting process).

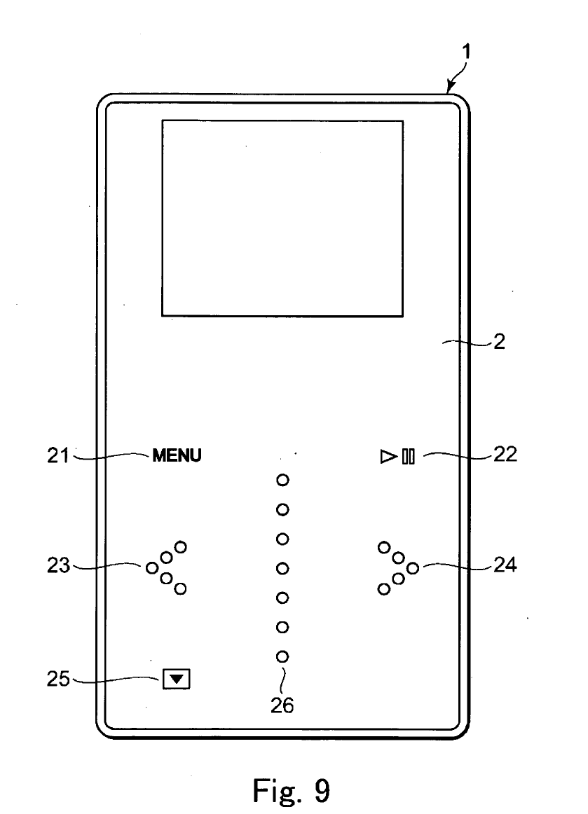

At this time, the CPU 51 instructs the LED controller 30 of the touch pad 5 to start via the touch pad controller 59. Then, the LED controller 30 makes all the LED elements 29a to 29f disposed corresponding to the operation buttons 21 to 26 to emit light for a certain time. The lights emitted from the LED elements 29a to 29f are guided by the light-guide 32 to the holes 27a to 27f disposed in the corresponding operation buttons 21 to 26, and passed from the holes 27a to 27f through the corresponding first translucent sections 45a to 45f to light and display the first surface 42 of the operation panel 2, i.e., the front side of the player main body 1. In other words, as shown in FIG. 9, the positions of all the operation buttons including the menu button 21, the play/stop button 22, the backward button 23, the forward button 24, the display button 25, and the scroll button 26 are lit to be displayed in the operation panel 2.

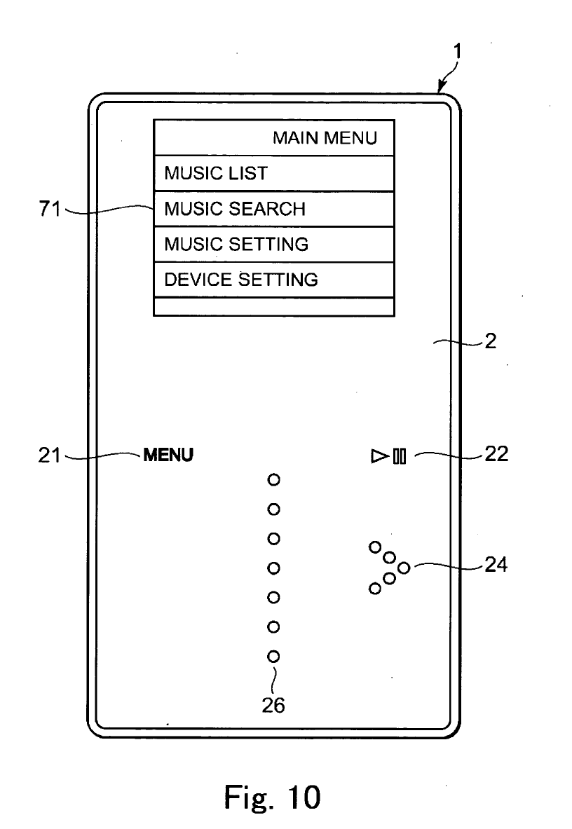

Subsequently, when an idle sate is set after a certain time, the CPU 51 displays a main menu 71 in the liquid crystal display 15. The CPU 51 instructs the LED controller 30 to extinct the lights of the backward button 23 and the display button 25. Then, the LED controller 30 turns lights off for the LED elements 29c, 29e corresponding to the backward button 23 and the display button 25. Accordingly, as shown in FIG. 10, the menu button 21, the play/stop button 22, the forward button 24, and the scroll button 26 only are lit to be displayed in the operation panel 2, while the backward button 23 and the display button 25 are substantially invisible or difficult to notice.

In this state, when menu button 21 is operated by touching, the CPU 51 switches a screen of the liquid crystal display 15 to a menu of another mode (e.g., setting mode). When the play/stop button 22 is operated by touching, music playing starts. When the scroll button 26 is operated by touching in a tracing manner, a pointer of the main menu screen 71 moves. When the backward button 24 is operated by touching, the screen of the liquid crystal display 15 switches to a submenu of a lower layer with respect to a menu designated by the pointer. Even when the backward button 23 and the display button 25 are operated by touching, the CPU 51 does not operate. Thus, in the idle state after the start, the backward button 23 and the display button 25 are inoperable. In this case, as the only operable other buttons 21, 22, 24, and 26 are lit to be displayed in the operation panel 2, there is less possibility that the operator will try to operate the backward button 23 or the display button 25 by mistake.

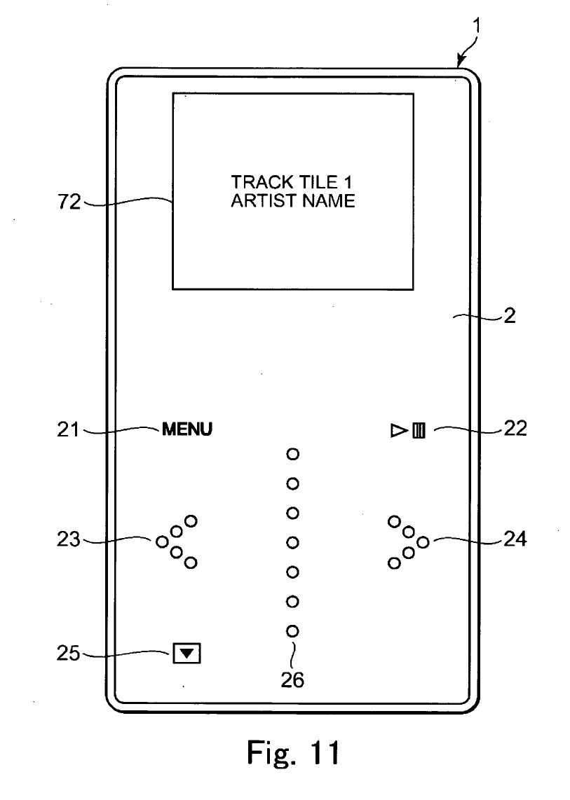

Upon a start of the music playing, the CPU 51 switches the screen of the liquid crystal display 15 from the main menu 71 to a play display 72. The Cup instructs the LED controller 30 that the backward button 23 and the display button 25 are operable now (instruction process). Then, the LED elements 29a to 29f corresponding to the backward button 23 and the display button 25 emit light, whereby the backward button 23 and the display button 25 that was hard to be seen are lit to be visible again on the operation panel 2 as shown in FIG. 11.

In this state, upon a touch-operation of the main menu 21, the CPU 51 returns the screen of the liquid crystal display 15 to the main menu 71. Upon a touch-operation of the play/stop button 22, the music playing stops. When the scroll button 26 is operated by touching in a tracing manner, a volume is adjusted. Upon a touch-operation of the forward button 24, the process skips to the next music. Upon a touch-operation of the backward button, the process skips to the previous music. Upon a touch-operation of the display button 25, the screen of the liquid crystal display 15 is changed to a lyrics display. During music playing, all the operation buttons 21 to 26 are operable, thus all of the operation buttons are lit to be displayed on the operation panel 2. As a result, the operator can easily operate a desired button.

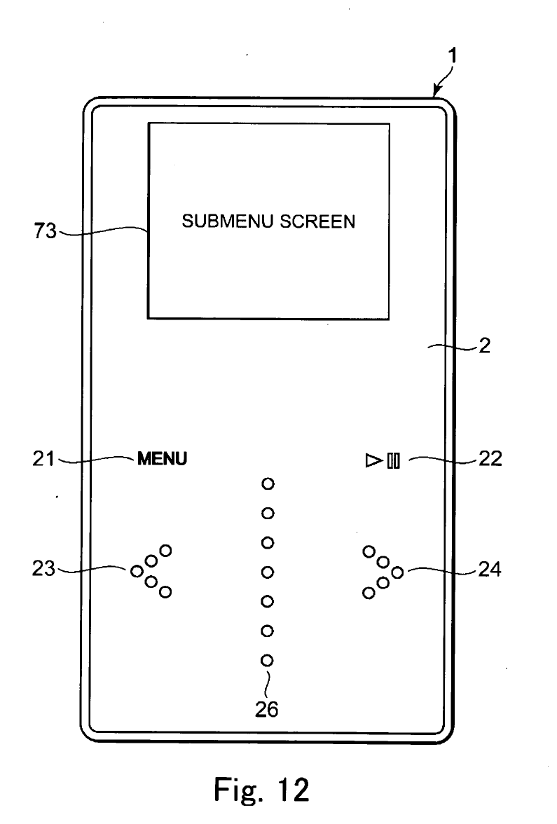

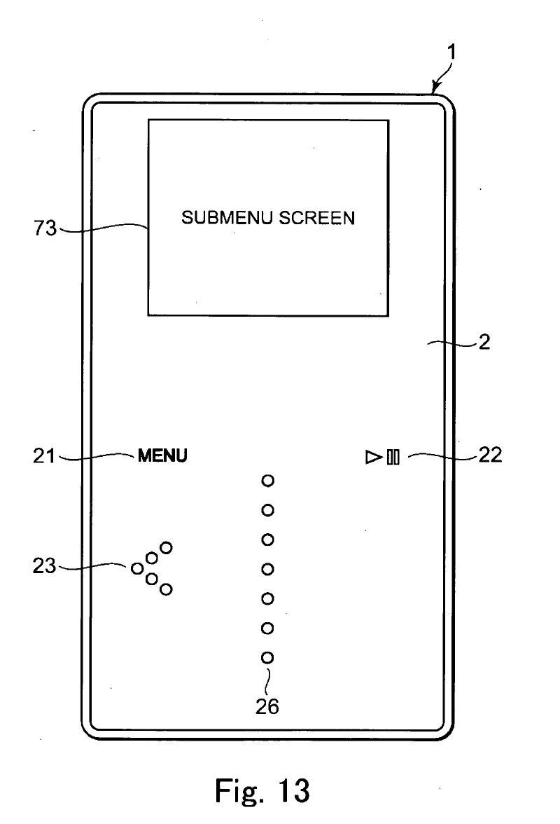

On the other hand, when the forward button 24 is operated by touching in an idle state, the screen of the liquid crystal display 15 changes to the submenu screen 73. Then, the CPU 51 instructs the LED controller 30 the backward button 23 in operable now (instruction process). Accordingly, the LED element 29c corresponding to the backward button 23 emits light, whereby the backward button 23 that was hard to be seen is lit to be displayed and becomes visible again on the operation panel 2 as shown in FIG. 12.

when the menu button 21 is operated by touching in this state, the CPU 51 switches the screen of the liquid crystal display 15 to the main menu 71. Upon a touch-operation of the play/stop button 22, music playing starts. When the scroll button 26 is operated by touching in a tracing manner, the pointer of the screen moves. Upon a touch-operation of the forward button 24, the screen of the liquid crystal display 15 is switched to a subscreen menu of a further lower layer with respect to the menu designated by the pointer. Upon a touch-operation of the backward button 23, the screen of the liquid display 15 is switched to a menu of a layer higher by one step. Even when the display button 25 is operated by touching, the CPU 51 does not operate. Accordingly, the display button 25 is inoperable when the submenu screen 73 is displayed. In this case, as the only operable other buttons 21, 22, 23, 24, and 26 are lit to be displayed in the operation panel 2, there is only a small possibility that the operator will try to operate the display button 25 by mistake.

In the case of displaying a menu of the next layer by an operation input of the forward button 24, if there is no submenu of a lower layer, i.e., when a submenu of the lowest layer is displayed, the CPU 51 instructs the LED controller 30 that the forward button is inoperable now (instruction process). As a result, the LED element 29d corresponding to the forward button 24 stops the light emission, whereby the forward button 24 is made hard to be seen on the operation panel 2.

In this state, the CPU 51 does not operate even when the forward button 24 is operated by touching. Accordingly, on the submenu of the lowest layer, the display button 25 and the forward button 24 are both inoperable. In this case, as the only operable other buttons 21, 22, 23, and 26 only are lit to be displayed in the operation panel 2, there is only a small possibility that the operator will try to operate the display button 25 or the forward button 24 by mistake.

The aforementioned operation of the portable type music player shows only an example. It is obvious that the present invention is not limited to this example.

According to the embodiment, the touch pad 5 using the touch input sensor of the electrostatic capacity detecting type is used as the operation input unit 7. As a result, costs can be largely reduced compared with a device using a touch panel operation section with a display member such as a liquid crystal display panel.

In the embodiment, the operation buttons 21 to 26 as the plurality of touch input sensors are arranged to face the backside of the operation panel 2, and the LED elements 29a to 29f and the light-guide 32 are disposed corresponding to the operation buttons 21 to 26. In the front of the operation panel 2, the positions of the arranged operation buttons 21 to 26 are displayed by light-emissions, thereby indicating the presence of the operation buttons 21 to 26 to the operator. As a result, the front of the operation panel 2 can be formed into a smooth single plane. In other words, the front of the operation panel 2 can be formed into a plane having no concave or convex sections formed to indicate the positions of the touch input sensors. Therefore, the front of the player main body 1 can be designed without concave and convex sections, a beautiful product design can be made.

Besides, among the positions of the arranged operation buttons 21 to 26, only the positions of the arranged operation buttons that are operable in the next process are displayed by light-emission, while the inoperable buttons are made hard to be seen on the operation panel 2. As a result, there is only a small possibility that the operator will confuse and try to operate the inoperable button by mistake. Therefore, it is possible to provide a product of high operability.

The backside of the operation panel 2 is covered with the non-translucent layer 47 except the first translucent sections 45a to 45f corresponding to the positions of the plurality of arranged touch input sensors. Accordingly, the light rays from the LED elements 29a to 29f respectively pass through the corresponding first translucent sections 45a to 45f to light and display the backside of the operation panel 2. As a result, it is possible to prevent easy visibility of the inoperable button on the operation panel 2 caused by a light emitted from the LED element corresponding to an operable button.

In addition, the deposited film 44 is provided between the operation panel 2 and the non-translucent layer 47 in the backside of the operation panel 2. Accordingly, the operation panel 2 acts as a half mirror when seen from the front side, whereby the inoperable button with the corresponding LED element of no light emission is made hard to be seen on the operation panel 2.

Besides, as the first translucent layer 45 has the light diffusion layer 48 provided thereon for exerting a light diffusion process, the inoperable button can be made hard to be seen on the operation panel 2 more surely.

As the operation panel 2 covers the liquid crystal display 15 which is an information display section, it is possible to reduce the number of components without any need to dispose a special cover. The entire operation panel including the information display section can be formed into a single plane of no concave or convex sections to acquire more beautiful appearance. Moreover, as the second translucent section 46 corresponding to the liquid crystal display 15 is higher in transparency than the first translucent sections 45a to 45f corresponding to the operation buttons 21 to 26, information displayed in the liquid crystal display 15 can be displayed with high quality in the display section 6 in the front of the operation panel 2.

When the portable type music player is activated from the stopped state to the normal operation state, all the LED elements 29a to 29f corresponding to the operation buttons 21 to 26 emit light for a predetermined time. Therefore, the device is advantageous in that the operator can check the positions of all the operation buttons 21 to 26 arranged in the operation input section 7 at the time of starting.

However, the present invention is not limited to the described embodiment.

For example, according to the embodiment, the first surface 42 of the operation panel 2 is formed into a single plane in which the area of the predetermined range including the operation input section 7 is smooth one. However, it does not need to be always a smooth single plane. What is required is that such a structure is employed in which among the plurality of touch input sensors (operation buttons 21 to 26) arranged on the second surface 43 side of the operation panel, the operable touch input sensor only is displayed by light-emission in the first surface 42.

According to the embodiment, the operation panel 2 is formed integrally with the cover of the liquid crystal display 15. However, the operation panel 2 and the cover can be separately formed.

According to the embodiment, the LED elements 29a to 29f are used as the light emission elements. However, light emission elements other than the LED elements can be applied.

The embodiment has been described by using the electrostatic capacity detecting type sensor as the best-suited touch input sensor. However, not limited to this, other type of sensors or switches can be employed such as an ultrasonic type, an optical or resistance film type, for the touch input sensors. In this case, the deposited film 44 does not need to be nonconductive according to its configuration.

This invention can be applied and modified to various fields such as an electric device using touch type input operation other than the portable music player.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An operation input device comprising:
an operation panel including a first surface and a second surface opposing to the first surface, the second surface being provided with a half mirror-deposited film;
a plurality of touch input sensors of an electrostatic capacity detecting type arranged to face the second surface of the operation panel;
a light emitting display section including light emitting display elements to emit and display a light in positions of the plurality of arranged touch input sensors; and
a light emitting display control section for making only the light emitting display element corresponding to an operable touch input sensor among the plurality of touch input sensors to emit light.

2. The operation input device according to claim 1, wherein an operation area of the first surface is a single smooth plane.

3. The operation input device according to claim 1, wherein the second surface is covered with a non-translucent layer except for translucent sections corresponding to the positions of the plurality of arranged touch input sensors.

4. The operation input device according to claim 3, wherein the light emitting display elements light the operation panel through the translucent sections.

5. The operation input device according to claim 4, wherein the light emitting display elements are individually arranged on the second surface side of the operation panel with respect to positions of the translucent sections.

6. The operation input device according to claim 5, further comprising a light-guide section for guiding light rays emitted from the light emitting display elements to the translucent sections.

7. The operation input device according to claim 3, wherein a light diffusion processing is applied to at least one of the translucent sections.

8. The operation input device according to claim 3, wherein the non-translucent layer is dark color or metal color of silver or gold such that the transparent sections become obscure when being looked from the first surface.

9. The operation input device according to claim 8, wherein the dark color is one selected from black, deep blue, deep green, deep brown, deep purple, and deep gray.

10. The operation input device according to claim 8, wherein brightness of color of the non-translucent layer is 30% or less.

11. The operation input device according to claim 1, wherein the operation panel is a transparent plate.

12. The operation input device according to claim 1, wherein the deposited film is nonconductive.

13. The operation input device according to claim 1, wherein the light emission elements are LED elements.

14. An electronic device comprising:
an operation panel including a first surface, and a second surface having a half mirror-deposited film formed therein;
a plurality of touch input sensors of an electrostatic capacity detecting type arranged to face the second surface;
light emitting display sections for emitting and displaying a light in positions of the plurality of arranged touch input sensors;
an operation control section for controlling an operation of the electronic device based on inputs from the touch input sensors;
a designation section for designating an operable touch input sensor among the plurality of touch input sensors based on the operation controlled by the operation control section; and
a light emitting display control section for making the light emitting display section corresponding to the touch input sensor designated by the designation section to emit light.

15. The electronic device according to claim 14, wherein the operation panel is formed integrally with a cover which covers an information display section to display operation state information of the electronic device.

16. The electronic device according to claim 14, wherein the second surface is covered with a non-translucent layer except for first translucence sections corresponding to the positions of the plurality of arranged touch input sensors and a second translucent section corresponding to the information display section.

17. The electronic device according to claim 16, wherein the second translucent section is higher in transparency than the first translucent sections.

18. The electronic device according to claim 14, wherein all the light emitting display elements emit lights for a certain time when a stopped state is changed to a normal operation state.
